(19) United States
(12) Patent Application Publication
(10) Pub. No.: US 2008/0142730 A1
(43) Pub. Date: Jun. 19, 2008

(54) Fluorescence detecting device

(75) Inventors: Masao Makiuchi, Kawasaki (JP); Kazuko Matsumoto, Tokyo (JP)

Correspondence Address: KRATZ, QUINTOS & HANSON, LLP, 1420 K Street, N.W., Suite 400, WASHINGTON, DC, 20005, US

(73) Assignees: FUJITSU LIMITED, Kawasaki (JP); WASEDA UNIVERSITY, Tokyo (JP)

(21) Appl. No.: 11/979,579

(22) Filed: Nov. 6, 2007

(30) Foreign Application Priority Data
Nov. 7, 2006 (JP) JP2006-301610

(51) Int. Cl. G01N 21/64

(52) U.S. Cl. 250/458.1

(57) ABSTRACT

To provide a technology of increasing a sensitivity of detecting fluorescence. A fluorescence detecting device includes an excitation light source emitting excitation light that excites a fluorescence-marked measured object, a first optical path via which the excitation light impinges on the fluorescence-marked measured object, a detector detecting fluorescence emitted when the excitation light impinges on the fluorescence-marked measured object, a second optical path via which the fluorescence gets incident on the detector, and a chopper chopping the excitation light passing through the first optical path and the fluorescence passing through the second optical path, and thus controlling a relative relationship between a passage period of the excitation light and a passage period of the fluorescence.

### FIELD OF THE INVENTION

The present invention relates to a fluorescence detecting device.

### DESCRIPTION OF RELATED ART

In the case of detecting fluorescence from a minute sample marked in fluorescence, excitation light impinges on the sample, and an intensity of the emitted fluorescence is detected. For example, there is a method of separating only the fluorescence with an optical filter and thus detecting the fluorescence. This method utilizes a slight difference in wavelength between the excitation light and the fluorescence emitted during irradiation of the excitation light. Further, another method is a time-resolved fluorescence detecting method of detecting the fluorescence after cutting the excitation light. This time-resolved fluorescence detecting method makes the use of a fluorescent agent from which the fluorescence is emitted for a short while even after cutting the excitation light.

[Patent document 1] Japanese Patent Application Laid-Open Publication No. 2002-286639
[Patent document 2] Japanese Patent Application Laid-Open Publication No. 2004-271215

FIG. 1 is a diagram illustrating a fluorescence detecting device that requires a dichroic mirror 2. Pulses of excitation light emitted by a pulse excitation light source 1 impinge on a minute sample 4 marked in fluorescence. Then, the fluorescence emitted by the fluorescence-marked minute sample 4 is led via an objective lens 3 to a photo detector 5, thereby detecting an intensity of the fluorescence. Further, measurement starting time and a measurement time range of the photo detector 5 are controlled based on a trigger signal given from the pulse excitation light source 1. Moreover, such a case might exist that the irradiation of the excitation light pulses takes place not only once but also a plural number of times (twice to several tens thousand times) at an interval of fixed time. In this case, fluxes of fluorescence acquired are integrated and thus measured. The fluorescence detecting device shown in FIG. 1 can use both of these detection methods.

As shown in FIG. 1, the excitation light pulses emitted by the pulse excitation light source 1 are reflected by the dichroic mirror 2. Then, the excitation light pulses reflected by the dichroic mirror 2 impinge on the fluorescence-marked minute sample 4 via the objective lens 3. The fluxes of fluorescence emitted from the fluorescence-marked minute sample 4 are converged by the objective lens 3. Then, the thus-converged fluxes of fluorescence are received by the photo detector 5.

The excitation light having a predetermined wavelength impinges on the fluorescence-marked minute sample 4, and hence a filter BP6 is provided between the pulse excitation light source 1 and the dichroic mirror 2. Further, a filter BP7 is provided between the photo detector 5 and the dichroic mirror 2 in order to detect the fluorescence having a predetermined wavelength from the fluxes of fluorescence emitted from the fluorescence-marked minute sample 4.

The excitation light is reflected by the dichroic mirror 2, and consequently a detecting sensitivity of the photo detector 5 declines. Moreover, the excitation light is attenuated by the filter BP6, and the fluorescence is attenuated by the filter BP7, with the result that the detecting sensitivity of the photo detector 5 declines. Still further, the objective lens 3, which transmits the excitation light and the fluorescence, has a wide transmissive band but is inevitably priced high.

Next, a fluorescence detecting device requiring none of the dichroic mirror 2 will be described. FIG. 2 is a diagram illustrating the fluorescence detecting device requiring none of the dichroic mirror 2. The fluorescence detecting device requiring none of the dichroic mirror 2 uses an optical fiber 8 for leading the excitation light to the fluorescence-marked minute sample 4. The excitation light is led into the optical fiber 8 from a laser 9 for the excitation. An optical chopper 10 intercepts and transmits the excitation light, thereby generating the excitation light pulses. Further, the objective lens 3 transmits only the fluorescence. Therefore, the objective lens 3 involves using a lens having a maximum transmittance with a wavelength of the fluorescence emitted from the fluorescence-marked minute sample 4.

The excitation light does not get incident on the objective lens 3 because of an incidence angle of the optical fiber 8 and a numerical aperture (NA) of the objective lens 3. Therefore, the excitation light does not need passing through the filter. Because of using the objective lens 3, however, the fluorescence detecting device is hard to be downsized in the future. Moreover, an incidence efficiency is determined only by the objective lens 3. Moreover, in the case of using the objective lens 3, it is difficult to make a high efficient detection. Even with this configuration, the fluorescence detecting device can employ both of these detection methods. Each of the fluorescence detecting devices described above is large of the device configuration due to spatial propagation of the excitation light, the fluorescence convergence using the objective lens 3, the introduction of the spectral filters, etc. It is an object of the present invention to provide a technology of simplifying and downsizing the fluorescence detecting device. Further, the conventional fluorescence detecting devices are not designed to detect the fluorescence with a high sensitivity. The present invention aims at, in the fluorescence detecting device, providing a technology of increasing the sensitivity for detecting the fluorescence.

### SUMMARY

Namely, a fluorescence detecting device according to the present invention includes an excitation light source emitting excitation light that excites a fluorescence-marked measured object, a first optical path via which the excitation light impinges on the fluorescence-marked measured object, a detector detecting fluorescence emitted when the excitation light impinges on the fluorescence-marked measured object, a second optical path via which the fluorescence gets incident on the detector, and a chopper chopping the excitation light passing through the first optical path and the fluorescence passing through the second optical path, and thus controlling a relative relationship between a passage period of the excitation light and a passage period of the fluorescence.

### BRIEF DESCRIPTION OF THE DRAWINGS

FIG. 1 is a diagram showing a fluorescence detecting device requiring a dichroic mirror 2.

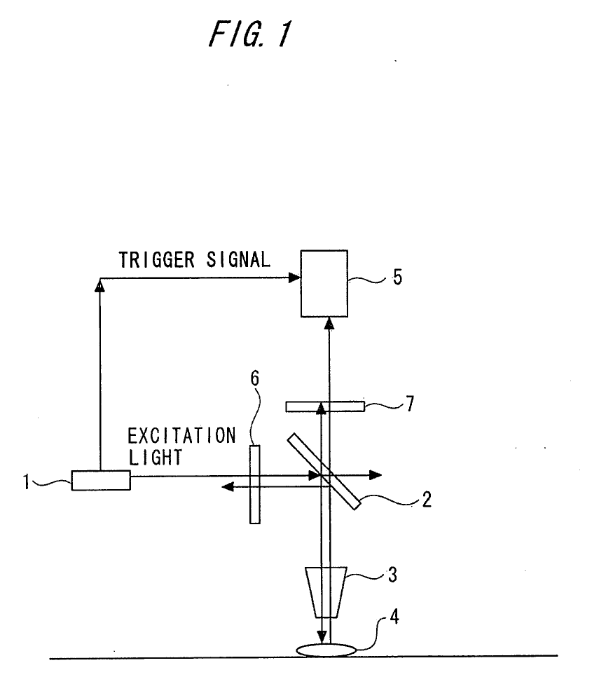

FIG. 2 is a diagram showing a fluorescence detecting device requiring none of the dichroic mirror 2.

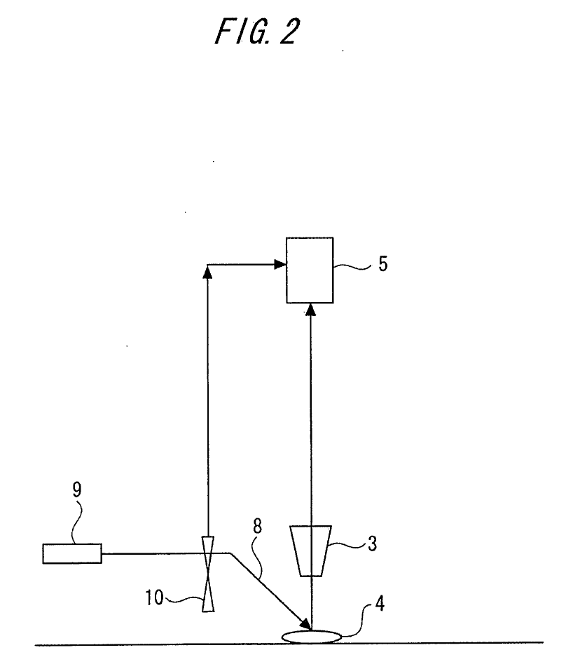

FIG. 3 is a schematic diagram of the fluorescence detecting device according to a first embodiment.

FIG. 4 is an explanatory diagram of an optical fiber.

FIG. 5 is an explanatory diagram of a binding lens.

FIG. 6 is a graph showing a fluorescent intensity of fluorescence emitted from a measured object.

FIG. 7 is a graph showing variations in fluorescent intensity.

FIG. 8 is a graph showing a relationship between the fluorescent intensity of the fluorescence emitted by a marking agent and an elapsed time.

FIG. 9 is a graph showing a relationship between a fluorescent intensity of the fluorescence emitted from an area other than the marking agent and an elapsed time.

FIG. 10 is a top view illustrating one working example of a optical chopper 304 in the first embodiment.

FIG. 11 is a top view illustrating another working example of the optical chopper 304 in the first embodiment.

FIG. 12 is a diagram showing periods of time for which the excitation light and the fluorescence pass through slits.

FIG. 13 is a diagram showing periods of time for which the excitation light and the fluorescence pass through slits.

FIG. 14 is a diagram showing an example of structure of a tip of the optical fiber.

FIG. 15 is a diagram showing an example of structure of the tip of the optical fiber.

FIG. 16 is a diagram showing an example of structure of the tip of the optical fiber.

FIG. 17 is a diagram showing an example of structure of the tip of the optical fiber.

FIG. 18 is a diagram showing an example of structure of the tip of the optical fiber.

FIG. 19 is a diagram showing a specific example of configuration of the fluorescence detecting device in the first embodiment.

FIG. 20 is a diagram showing a specific example of configuration of the fluorescence detecting device in the first embodiment.

FIG. 21 is a diagram showing a specific example of configuration of the fluorescence detecting device in the first embodiment.

FIG. 22 is a top view of a to-be-measured object mounting base plate 305 formed with a flow path 2201.

FIG. 23 is an explanatory diagram of the fluorescence detecting device according to a second embodiment.

FIG. 24 is an explanatory diagram of the fluorescence detecting device according to a third embodiment.

### DETAILED DESCRIPTION

A fluorescence detecting device according to a best mode (which will hereinafter be termed an embodiment) for carrying out the present invention will hereinafter be described with reference to the drawings. Configurations in the following embodiments are exemplifications, and the present invention is not limited to the configurations in the embodiments.

### First Embodiment

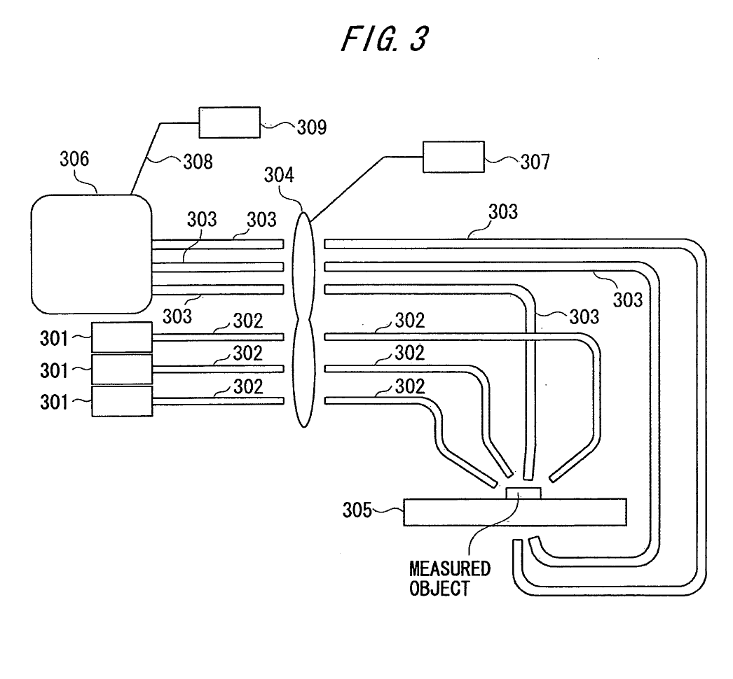

FIG. 3 shows a schematic diagram of the fluorescence detecting device according to a first embodiment. As illustrated in FIG. 3, the fluorescence detecting device in the first embodiment includes excitation light sources 301, optical fibers 302 for the excitation light sources, optical fibers 303 for detecting fluorescence, a rotary optical chopper 304, a to-be-measured object mounting base plate 305 on which an object to be measured is mounted, and a photo detector 306. The excitation light source 301 involves using, e.g., a xenon lamp. Further, the optical chopper 304 is connected to an optical chopper controller 307. The optical chopper controller 307 controls rotations of the optical chopper 304. The photo detector 306 is connected via a bus 308 to a personal computer 309. The personal computer 309 is preinstalled with software for collecting data and for controlling a variety of devices. The fluorescence and an intensity of fluorescence, which are detected by the photo detector 306, are sent to the personal computer 309 via the bus 308. The personal computer 309 is employed for collecting and analyzing the fluorescence and the intensity of the fluorescence detected by the photo detector 306. Further, the personal computer 309 is of a generally known type, and a configuration and an operation thereof are therefore omitted herein.

To begin with, excitation light generated by the excitation light source 301 gets incident on the optical fiber 302 for the excitation light source. The excitation light getting incident on the optical fiber 302 for the excitation light source exits a tip, facing the measured object, of the optical fiber 302 for the excitation light source. Then, the excitation light exiting the tip of the optical fiber 302 for the excitation light source impinges on the measured object on the to-be-measured object mounting base plate 305. The measured object on the to-be-measured object mounting base plate 305 is marked in fluorescence. The fluorescence emitted from the measured object becomes incident upon a tip of the optical fiber 303 for detecting the fluorescence. The fluorescence getting incident upon the tip of the optical fiber 303 for detecting the fluorescence enters the photo detector 306 from the optical fiber 303 for detecting the fluorescence.

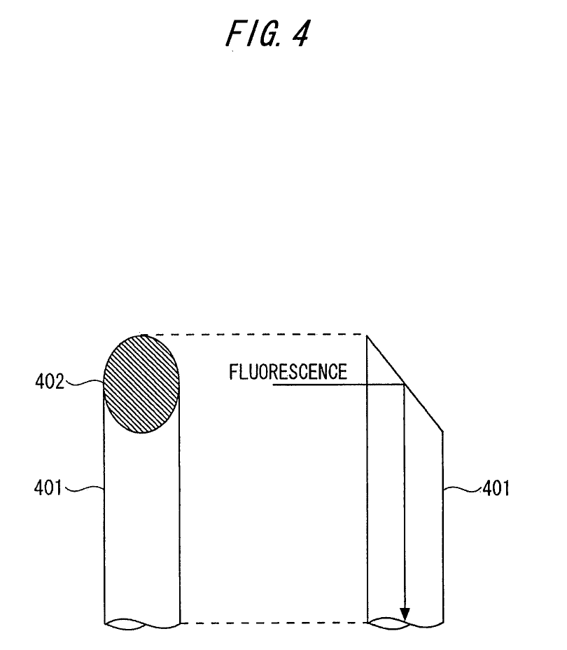

For instance, the optical fiber 302 for the excitation light source and the optical fiber 303 for detecting the fluorescence involve employing bamboo spear shaped optical fibers 401 (taking a shape in which a bamboo or a cylinder is cut off obliquely) as illustrated in FIG. 4. A metal coat 402 is applied over a tip of the optical fiber 401 in FIG. 4. The excitation light outgoes from the tip of the optical fiber 401 in FIG. 4. Further, the fluorescence getting incident upon the tip of the optical fiber 401 in FIG. 4 is reflected by the metal coat 402. Then, the fluorescence reflected by the metal coat 402 passes through inside the optical fiber 401.

In FIG. 3, fluxes of fluorescence are converged by the three excitation light sources 301, the three optical fibers 302 for the excitation light sources and the three optical fibers 303 for detecting the fluorescence. FIG. 3 shows a mere exemplification, and the numbers of the excitation light sources 301, the optical fibers 302 for the excitation light sources and the optical fibers 303 for detecting the fluorescence, are not limited to these numerical values.

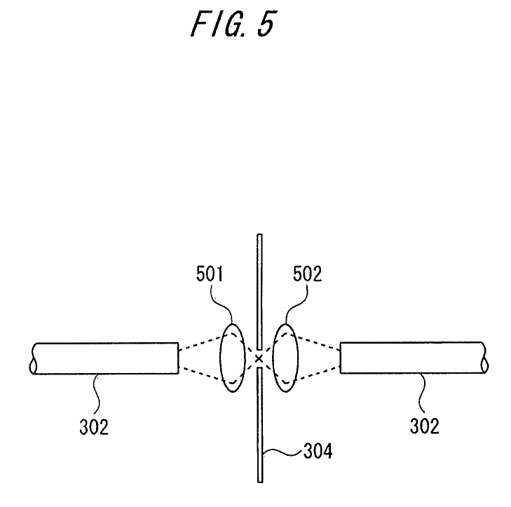

Further, as shown in FIG. 3, the optical chopper 304 is provided between the optical fibers 302 for the excitation light source and the optical fibers 302 for the excitation light source. Moreover, as illustrated in FIG. 3, the optical chopper 304 is provided also between the optical fibers 303 for detecting the fluorescence and the optical fibers 303 for detecting the fluorescence. For example, the optical chopper 304 cuts off (chops) the excitation light and the fluorescence at a predetermined interval by rotating fast a metal plate formed with slits. The excitation light and the fluorescence are cut off at the predetermined interval, whereby the excitation light and the fluorescence are pulsated. Further, binding lenses illustrated in FIG. 5 are constructed in order to reduce a loss caused by divergences of the excitation light and the fluorescence.

As illustrated in FIG. 5, a lens 501 and a lens 502 are interposed between the optical fiber 302 for the excitation light source and the optical fiber 302 for the excitation light source. The excitation light beams emerging from the optical fiber 302 for the excitation light source are converged by the lens 501. The excitation light beams converged by the lens 501 are chopped at the predetermined interval by the optical chopper 304 and are thereby pulsated. The pulsated excitation light beams are converged by the lens 502 and get incident on the optical fiber 302 for the excitation light source. The lens 501 and the lens 502 shown in FIG. 5 are interposed between the optical chopper 304 and the optical fibers 302 for the excitation light source, thereby reducing the loss due to the divergence of the excitation light.

Further, similarly to the configuration illustrated in FIG. 5, the lens 501 and the lens 502 are interposed between the optical fiber 303 for detecting the fluorescence and the optical fiber 303 for detecting the fluorescence. The use of the configuration similar to that in FIG. 5 leads to a decrease in loss due to the divergence of the fluorescence.

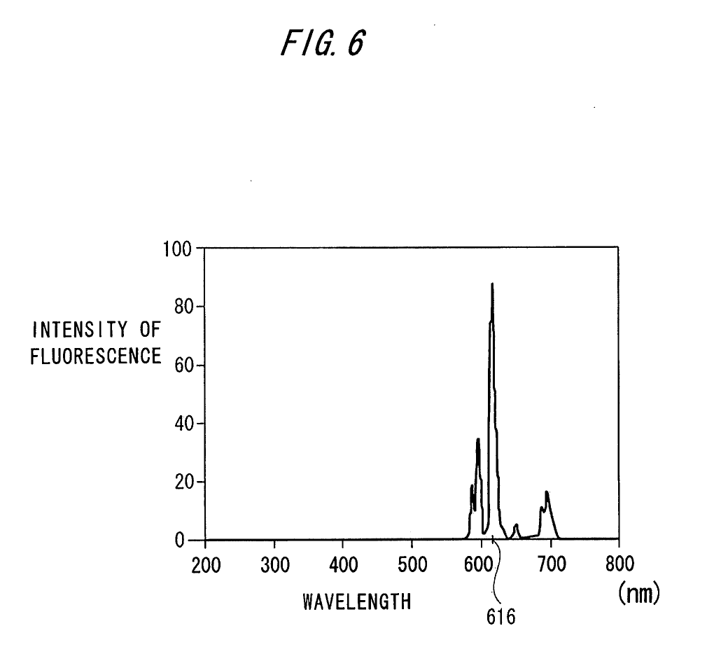

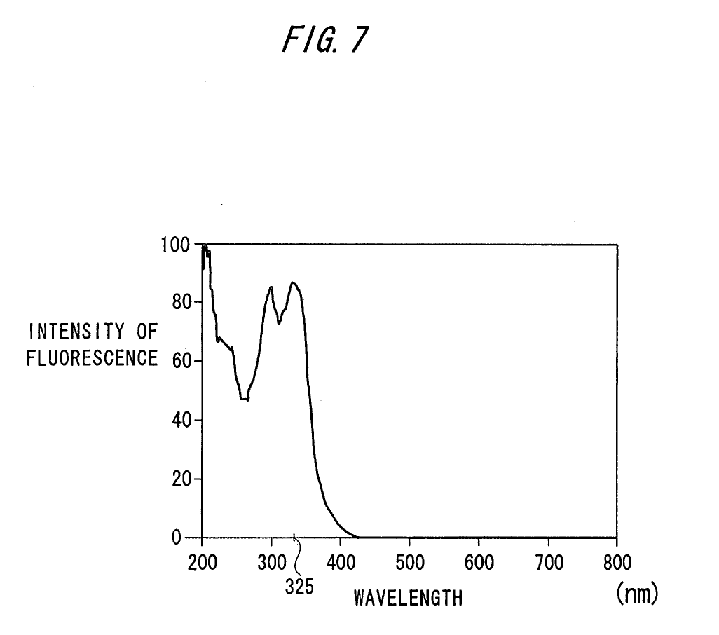

Next, a wavelength of the excitation light striking on the measured object will be described with reference to FIG. 7. FIG. 6 is a graph showing a fluorescent intensity of the fluorescence emitted by the measured object. The measured object is marked in fluorescence with a marking agent. Moreover, the marking agent involves using a mixture of rare earth elements such as europium (Eu) and terbium (Tb).

At first, the excitation light impinges on the fluorescence-marked measured object. In this case, the excitation light, of which a wavelength is on the order of 325 nm (nanometers), impinges on the fluorescence-marked measured object. The axis of ordinate in FIG. 6 represents the intensity of the fluorescence. Further, the axis of abscissa in FIG. 6 represents a wavelength of the fluorescence detected from the fluorescence-marked measured object. When the excitation light having the wavelength of 325 nm impinges on the fluorescence-marked measured object, the fluorescence having a wavelength of 570 nm-720 nm is detected from the fluorescence-marked measured object. FIG. 6 shows the fluorescent intensity of the detected fluorescence in the case of detecting the fluorescence having the wavelength of 570 nm-720 nm from the fluorescence-marked measured object. As illustrated in FIG. 6, the fluorescence having the wavelength of 616 nm exhibits a high value of the fluorescent intensity.

Next, the photo detector 306 is set so as to detect the fluorescence having the wavelength of 616 nm. Then, the excitation light having the wavelength of 200 nm-500 nm impinges on the fluorescence-marked measured object. FIG. 7 is a graph showing variations in fluorescent intensity of the fluorescence detected from the fluorescence-marked measured object when the excitation light having the wavelength of 200 nm-500 nm impinges on the fluorescence-marked measured object. As shown in FIG. 7, when the excitation light having the wavelength of 200 nm impinges on the fluorescence-marked measured object, the fluorescent intensity of the fluorescence detected from the fluorescence-marked measured object exhibits the highest value. Further, as illustrated in FIG. 7, when the excitation light having the wavelength of 325 nm impinges on the fluorescence-marked measured object, the fluorescent intensity of the fluorescence detected from the fluorescence-marked measured object exhibits the second highest value. If the excitation light having the wavelength of 200 nm impinges on the fluorescence-marked measured object, however, the measured object such as a DNA chip might be destructed. Such being the case, the first embodiment involves employing the excitation light having the wavelength of 325 nm.

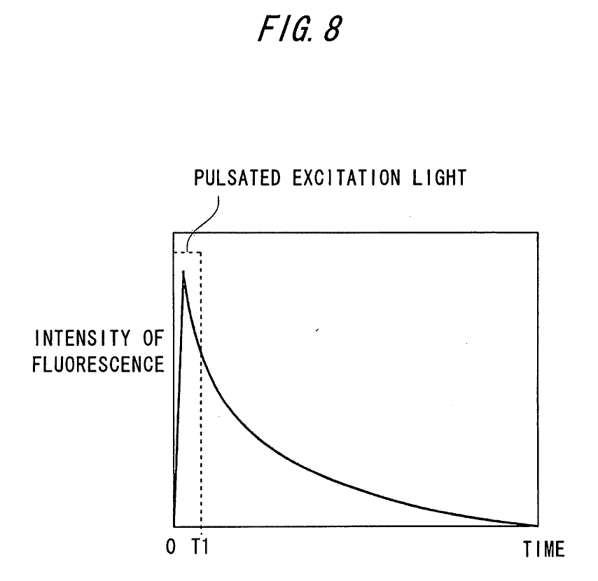

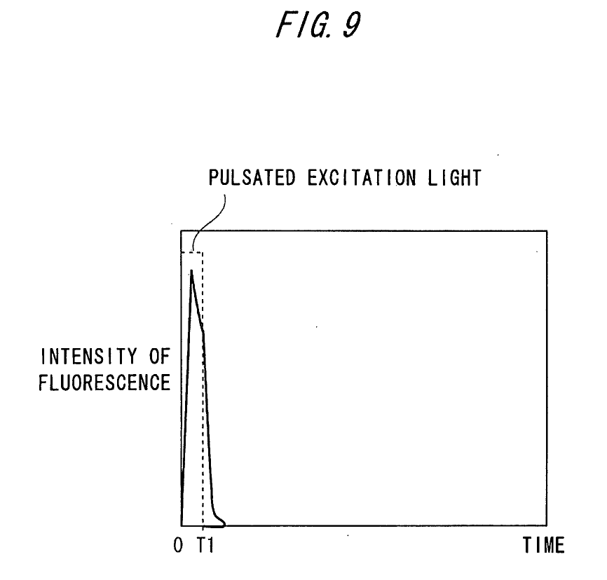

The variations in fluorescent intensity when the pulsated excitation light impinges on the fluorescence-marked measured object, will be described with reference to FIGS. 8 and 9. The axis of ordinate in each of FIGS. 8 and 9 represents the fluorescent intensity. Further, the axis of abscissa in each of FIGS. 8 and 9 represents elapsed time. When the pulsated excitation light impinges on the fluorescence-marked measured object, the fluorescence is emitted from the marking agent and an area other than the marking agent.

FIG. 8 is the graph showing a relationship between the fluorescent intensity of the fluorescence emitted from the marking agent and the elapsed time. As shown in FIG. 8, when the pulsated excitation light impinges on the fluorescence-marked measured object up to time T1, the fluorescent intensity of the fluorescence emitted from the marking agent exhibits a high value up to the time T1. A dotted line in FIG. 8 indicates a period of incidence time of the pulsated excitation light upon the fluorescence-marked measured object.

Then, as shown in FIG. 8, when over the time T1, the fluorescent intensity of the fluorescence emitted from the marking agent gently decreases. As shown in FIG. 8, after the pulsated excitation light has impinged on the fluorescence-marked measured object, a phenomenon that the marking agent emits the fluorescence for a while is called delayed fluorescence.

FIG. 9 is the graph showing a relationship between the fluorescent intensity of the fluorescence emitted from the area other than the marking agent and the elapsed time. As illustrated in FIG. 9, when the pulsated excitation light impinges on the fluorescence-marked measured object up to the time T1, the fluorescent intensity of the fluorescence emitted from the area other than the marking agent exhibits a high value up to the time T1. A dotted line in FIG. 9 indicates a period of incidence time of the pulsated excitation light upon the fluorescence-marked measured object. Then, as illustrated in FIG. 9, when over the time T1, the fluorescent intensity of the fluorescence emitted from the area other than the marking agent abruptly decreases.

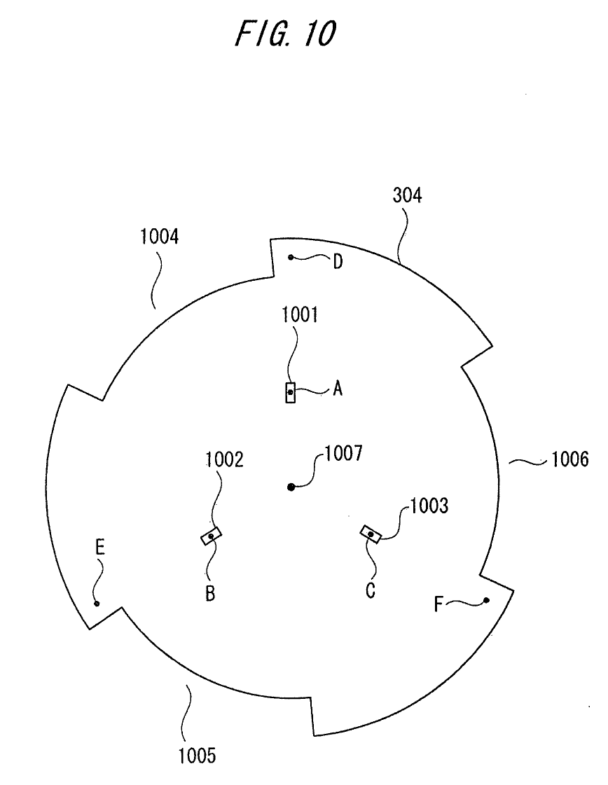

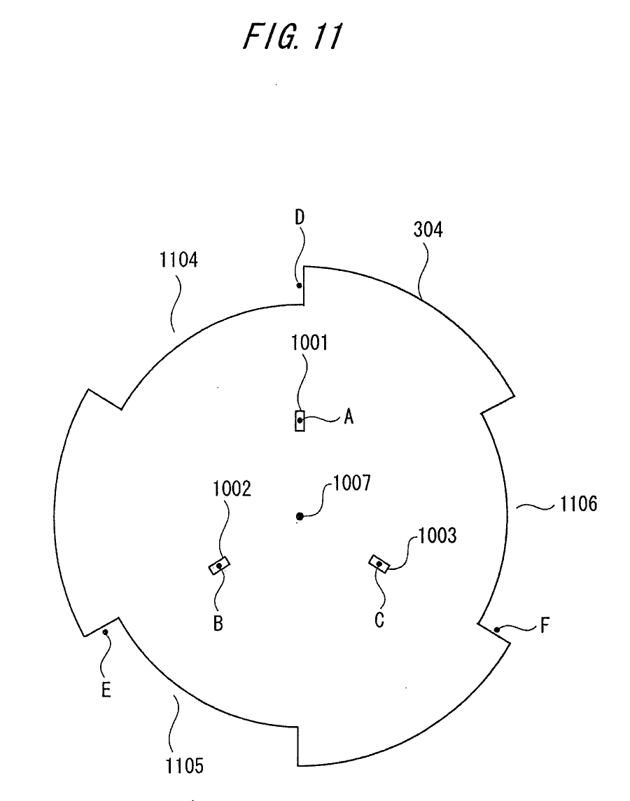

Next, the slits formed in the optical chopper 304 in the first embodiment will be described with reference to FIGS. 10 and 11. FIG. 10 is a top view illustrating one working example of the optical chopper 304 in the first embodiment. The optical chopper 304 is substantially a circular plate including a central point 1007. The optical chopper 304 is formed with slits 1001 through 1006. Namely, the optical chopper 304 is formed with predetermined notches.

The optical chopper 304 illustrated in FIG. 10 is on the order of 13 cm in its diameter. The slits 1001, 1002 and 1003 are formed in an area that is approximately 2.5 cm extending in an outer peripheral direction of the optical chopper 304 from the central point 1007 of the optical chopper 304. In this case, the slits 1001, 1002 and 1003 are respectively disposed at an equal interval.

The slits 1001, 1002 and 1003 are each formed approximately 2 mm in length and about 5 mm in width. The slits 1001, 1002 and 1003 are disposed so that longitudinal directions of the slits 1001, 1002 and 1003 are each coincident with the outer peripheral direction (radial direction) of the optical chopper 304 from the central point 1007 of the optical chopper 304.

Further, the band-shaped slits (notches) 1004, 1005 and 1006 are formed in an area that is approximately 5.4 cm extending in the outer peripheral direction of the optical chopper 304 from the central point 1007 of the optical chopper 304. In this case, the slits 1004, 1005 and 1006 are disposed at an equal interval along the circumference centered at the central point 1007.

The slits 1004, 1005 and 1006 are each set approximately 7 cm in length of a side circumscribed on the outer periphery of the optical chopper 304 and set about 1 cm in length of a side orthogonal to the outer periphery of the optical chopper 304. Further, the numerical values given above are exemplifications, and the optical chopper 304 in the first embodiment is not limited to these numerical values.

The optical chopper 304 illustrated in FIG. 10 is controlled by the optical chopper controller 307 so as to rotate rightward about the central point 1007. The excitation light beams outgoing from one of two connection ends of the optical fibers 302 for the excitation light source, which are continuously connected to each other, are converged at positions A, B and C in FIG. 10 by the lenses 501 in FIG. 5. During the rotations of the optical chopper 304, when the slits 1001, 1002 and 1003 in FIG. 10 come to the positions A, B and C in FIG. 10, the converged excitation light beams pass through the slits 1001, 1002 and 1003 in FIG. 10 and get incident on the other of two connections end of the optical fibers 302 for the excitation light source which are continuously connected to each other.

While on the other hand, during the rotations of the optical chopper 304, when the slits 1001, 1002 and 1003 in FIG. 10 do not come to the positions A, B and C in FIG. 10, the converged excitation light beams are chopped by the optical chopper 304.

Further, the fluxes of fluorescence outgoing from one of two connection ends of the optical fibers 303 for detecting the fluorescence, which are continuously connected to each other, are converged at positions D, E and F in FIG. 10 by the lenses 501 in FIG. 5. During the rotations of the optical chopper 304, when the slits 1004, 1005 and 1006 in FIG. 10 come to the positions D, E and F in FIG. 10, the converged fluxes of fluorescence pass trough the slits 1004, 1005 and 1006 in FIG. 10 and get incident on the other of two connection ends of the optical fibers 303 for detecting the fluorescence which are continuously connected to each other.

While on the other hand, during the rotations of the optical chopper 304, when the slits 1004, 1005 and 1006 in FIG. 10 do not come to the positions D, E and F in FIG. 10, the converged fluxes of fluorescence are chopped by the optical chopper 304.

FIG. 11 is a top view illustrating another working example of the optical chopper 304 in the first embodiment. The optical chopper 304 in FIG. 11 is designed so that the fluorescence passes through slits 1104, 1105 and 1106 simultaneously when the excitation light passes through slits 1001, 1002 and 1003 in FIG. 11. Namely, the fluorescence detecting device using the optical chopper 304 in FIG. 11 is capable of starting the detection of the fluorescence simultaneously when the excitation light impinges on the fluorescence-marked measured object. Other constructions are the same as the optical chopper 304 illustrated in FIG. 10 has.

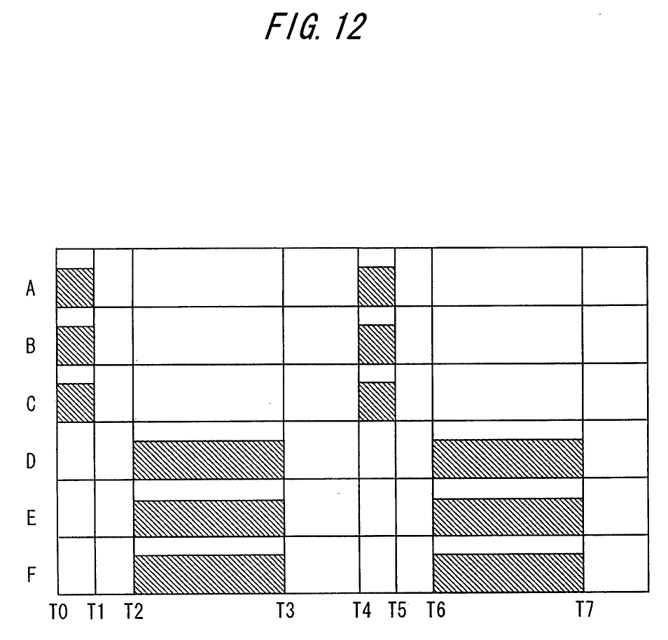

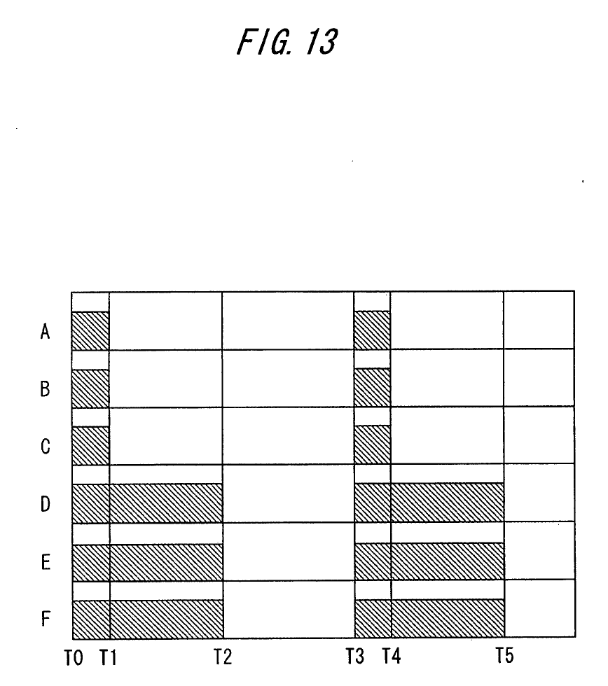

FIGS. 12 and 13 are diagrams showing periods of time for which the excitation light and the fluorescence pass through the respective slits. The letters A, B and C along the axis of ordinate in FIG. 12 represent the excitation light beams passing through the slits 1001, 1002 and 1003 in FIG. 10. The letters D, E and F along the axis of ordinate in FIG. 12 represent the fluxes of fluorescence passing through the slits 1104, 1105 and 1106 in FIG. 10. The axis of abscissa in FIG. 12 indicates the elapsed time.

The letters A, B and C along the axis of ordinate in FIG. 13 represent the excitation light beams passing through the slits 1001, 1002 and 1003 in FIG. 11. The letters D, E and F along the axis of ordinate in FIG. 13 represent the fluxes of fluorescence passing through the slits 1104, 1105 and 1106 in FIG. 11. The axis of abscissa in FIG. 13 indicates the elapsed time.

To start with, the graph shown in FIG. 12 will be explained. When the optical chopper 304 starts rotating, the excitation light beams converged at the positions A, B and C in FIG. 10 begin to pass through the slits 1001, 1002 and 1003. Then, when the elapsed time of the rotations of the optical chopper 304 reaches T1, the excitation light beams converged at the positions A, B and C in FIG. 10 are chopped by the optical chopper 304. Accordingly, as illustrated in FIG. 12, the excitation light beams pass through the slits 1001, 1002 and 1003 in FIG. 10 during a period of elapsed time of T0 to T1.

Then, till the elapsed time of the rotations of the optical chopper 304 reaches T4 shown in FIG. 12, the excitation light beams converged at the positions A, B and C in FIG. 10 are chopped by the optical chopper 304. When the elapsed time of the rotations of the optical chopper 304 reaches T4 shown in FIG. 12, the excitation light beams converged at the positions A, B and C in FIG. 10 start passing through the slits 1001, 1002 and 1003. Then, when the elapsed time of the rotations of the optical chopper 304 reaches T5 shown in FIG. 12, the excitation light beams converged at the positions A, B and C in FIG. 10 are chopped by the optical chopper 304. Accordingly, as shown in FIG. 12, the excitation light beams pass through the slits 1001, 1002 and 1003 in FIG. 10 during a period of elapsed time of T4 to T5.

Till the elapsed time of the rotations of the optical chopper 304 reaches T2 shown in FIG. 12, the fluxes of fluorescence converged at the positions D, E and F in FIG. 10 are chopped by the optical chopper 304. When the elapsed time of the rotations of the optical chopper 304 reaches T2 shown in FIG. 12, the fluxes of fluorescence converged at the positions D, E and F in FIG. 10 start passing through the slits 1004, 1005 and 1006. Then, when the elapsed time of the rotations of the optical chopper 304 reaches T3 shown in FIG. 12, the fluxes of fluorescence converged at the positions D, E and F in FIG. 10 are chopped by the optical chopper 304. Accordingly, as shown in FIG. 12, the fluxes of fluorescence pass through the slits 1004, 1005 and 1006 in FIG. 10 during a period of elapsed time of T2 to T3.

Till the elapsed time of the rotations of the optical chopper 304 reaches T6 shown in FIG. 12, the fluxes of fluorescence converged at the positions D, E and F in FIG. 10 are chopped by the optical chopper 304. When the elapsed time of the rotations of the optical chopper 304 reaches T6 shown in FIG. 12, the fluxes of fluorescence converged at the positions D, E and F in FIG. 10 start passing through the slits 1004, 1005 and 1006. Then, when the elapsed time of the rotations of the optical chopper 304 reaches T7 shown in FIG. 12, the fluxes of fluorescence converged at the positions D, E and F in FIG. 10 are chopped by the optical chopper 304. Accordingly, as shown in FIG. 12, the fluxes of fluorescence pass through the slits 1004, 1005 and 1006 in FIG. 10 during a period of elapsed time of T6 to T7.

Next, the graph shown in FIG. 13 will be explained. When the optical chopper 304 starts rotating, the excitation light beams converged at the positions A, B and C in FIG. 11 begin to pass through the slits 1001, 1002 and 1003. Then, when the elapsed time of the rotations of the optical chopper 304 reaches T1, the excitation light beams converged at the positions A, B and C in FIG. 11 are chopped by the optical chopper 304. Accordingly, as illustrated in FIG. 13, the excitation light beams pass through the slits 1001, 1002 and 1003 in FIG. 11 during a period of elapsed time of T0 to T1.

Then, till the elapsed time of the rotations of the optical chopper 304 reaches T3 shown in FIG. 13, the excitation light beams converged at the positions A, B and C in FIG. 11 are chopped by the optical chopper 304. When the elapsed time of the rotations of the optical chopper 304 reaches T3 shown in FIG. 13, the excitation light beams converged at the positions A, B and C in FIG. 11 start passing through the slits 1001, 1002 and 1003 in FIG. 11. Then, when the elapsed time of the rotations of the optical chopper 304 reaches T4 shown in FIG. 13, the excitation light beams converged at the positions A, B and C in FIG. 11 are chopped by the optical chopper 304. Accordingly, as shown in FIG. 13, the excitation light beams pass through the slits 1001, 1002 and 1003 in FIG. 11 during a period of elapsed time of T3 to T4.

When the optical chopper 304 starts rotating, the excitation light beams converged at the positions D, E and F in FIG. 11 begin to pass through the slits 1104, 1105 and 1106 in FIG. 11. Then, when the elapsed time of the rotations of the optical chopper 304 reaches T2 shown in FIG. 13, the excitation light beams converged at the positions A, B and C in FIG. 11 are chopped by the optical chopper 304. Accordingly, as illustrated in FIG. 13, the excitation light beams pass through the slits 1104, 1105 and 1106 in FIG. 11 during a period of elapsed time of T0 to T2.

Till the elapsed time of the rotations of the optical chopper 304 reaches T3 shown in FIG. 13, the fluxes of fluorescence converged at the positions D, E and F in FIG. 11 are chopped by the optical chopper 304. When the elapsed time of the rotations of the optical chopper 304 reaches T3 shown in FIG. 13, the fluxes of fluorescence converged at the positions D, E and F in FIG. 11 start passing through the slits 1104, 1105 and 1106 in FIG. 11. Then, when the elapsed time of the rotations of the optical chopper 304 reaches T5 shown in FIG. 13, the fluxes of fluorescence converged at the positions D, E and F in FIG. 11 are chopped by the optical chopper 304. Accordingly, as shown in FIG. 13, the fluxes of fluorescence pass through the slits 1104, 1105 and 1106 in FIG. 11 during a period of elapsed time of T3 to T5.

The excitation light is pulsated by employing the optical chopper 304 shown in FIG. 10, and the pulsated excitation light impinges on the fluorescence-marked measured object. In this case, when the excitation light impinges on the fluorescence-marked measured object, the fluorescence emitted from the fluorescence-marked measured object is chopped by the optical chopper 304. Then, after the elapse of the predetermined time, the fluorescence emitted from the fluorescence-marked measured object passes through the slits 1004, 1005 and 1006 of the optical chopper 304 in FIG. 10. Namely, the excitation light impinges on the fluorescence-marked measured object, and, after the elapse of the predetermined time, the fluorescence emitted from the fluorescence-marked measured object is detected.

Further, there might be a case in which the pulsated excitation light is reflected by the to-be-measured object mounting base plate 305 as well as by the fluorescence-marked measured object, and gets incident on the tip of the optical fiber 303 for detecting the fluorescence. In this case, the excitation light reflected by the measured object and by the to-be-measured object mounting base plate 305 enters the photo detector 306 from the optical fiber 303 for detecting the fluorescence. The excitation light is pulsated by use of the optical chopper 304 illustrated in FIG. 10 and impinges on the fluorescence-marked measured object, in which case the excitation light reflected by the measured object is chopped by the optical chopper 304. Therefore, according to the first embodiment, only the fluorescence emitted by the marking agent is detected. As a result, according to the first embodiment, it is feasible to perform the detection with a high sensitivity exhibiting a large S/N ratio.

A time width and a time interval for cutting off the excitation light traveling through the optical fibers 302 for the excitation light source are controlled depending on the positions of the respective slits formed in the optical chopper 304 in the first embodiment. As a result, the time width and the time interval of the excitation light impinging upon the fluorescence-marked measured object are controlled.

Further, the time width and the time interval for cutting off the excitation light traveling through the optical fibers 302 for the excitation light source are controlled depending on the number of rotations of the optical chopper 304 in the first embodiment. As a result, the time width and the time interval of the excitation light impinging on the fluorescence-marked measured object are controlled.

Moreover, the time width and the time interval for cutting off the excitation light traveling through the optical fibers 302 for the excitation light source are controlled depending on the positions of the respective slits formed in the optical chopper 304 in the first embodiment. Consequently, the time of starting the detection of the fluorescence emitted from the fluorescence-marked measured object is controlled. Further, the time width and the time interval of the fluorescence emitted from the fluorescence-marked measured object are also controlled.

Hence, the optical chopper 304 in the first embodiment is capable of controlling a relative relationship between a passage period of the excitation light passing through the optical fiber 302 for the excitation light source and a passage period of the fluorescence passing through the optical fiber 303 for detecting the fluorescence. The passage period of the excitation light passing through the optical fiber 302 for the excitation light source is controlled, thereby controlling the time width of the passage of the pulsated excitation light passing through the optical fiber 302 for the excitation light source, and also controlling the time interval of the passage of the pulsated excitation light passing through the optical fiber 302 for the excitation light source. The passage period of the fluorescence passing through the optical fiber 303 for detecting the fluorescence is controlled, thereby controlling the time width of the pulsated fluorescence passing through the optical fiber 303 for detecting the fluorescence, and also controlling the time interval of the pulsated fluorescence passing through the optical fiber 303 for detecting the fluorescence.

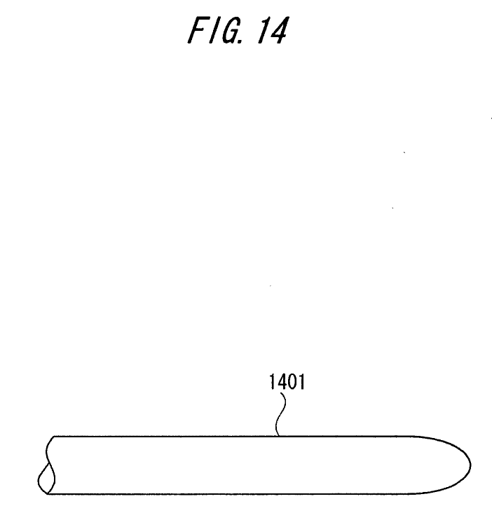

FIGS. 14 through 18 illustrate examples of construction of the tip of the optical fiber. As illustrated in FIG. 14, the tip of an optical fiber 1401 is convexed. For instance, the tip of the optical fiber 1401 is convexed by spherical surface working and tapered tip spherical working. The tip of the optical fiber 1401 is convexed, thereby enabling the excitation light beams to be converged and to thus outgo. Then, the converged excitation light beams outgo, whereby the excitation light efficiently impinges on the minute measured object.

Moreover, the convex tip (taking a structure of providing a convex lens at the tip of the cylindrical element) of the optical fiber 1401 enables the incident fluxes of fluorescence to be converged. Further, a converging position of the excitation light beams outgoing from the optical fiber 1401 can be any set by changing a curvature of the shape of the tip of the optical fiber 140. Still further, the tip of the optical fiber 1401 is convexed in FIG. 14, however, the tip of the optical fiber 1401 may also be concaved (taking a structure of providing a concave lens at the tip of the cylindrical element).

Furthermore, the optical fiber 1401 for the excitation light may also be formed thinner than normal. For example, the optical fiber 1401 for the excitation light may also be formed thinner than the optical fiber 1401 for the fluorescence. The optical fiber 1401 for the excitation light is formed thin, whereby a convergence rate of the outgoing excitation light beams is increased. Further, the optical fiber 1401 for the fluorescence may also be formed thicker than normal. For example, the optical fiber 1401 for the fluorescence may be formed thicker than the optical fiber 1401 for the excitation light. The optical fiber 1401 for the fluorescence is formed thick, whereby the convergence rate of the incident fluxes of fluorescence is increased.

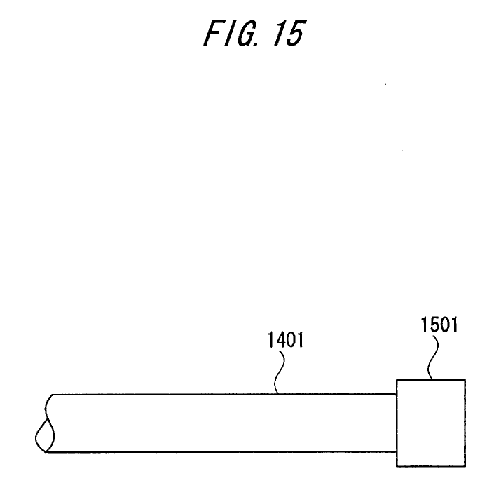

Moreover, as illustrated in FIG. 15, the tip of the optical fiber 1401 may be provided with a divergence angle adjusting member 1501. For instance, the divergence angle adjusting member 1501 involves using a micro lens, a spherical lens, a rod lens, a prism, an integration optical waveguide, etc. The tip of the optical fiber 1401 is provided with the divergence angle adjusting member 1501, whereby the convergence rate of the outgoing excitation light beams is increased. Further, the tip of the optical fiber 1401 is provided with the divergence angle adjusting member 1501, whereby the convergence rate of the incident fluxes of fluorescence is increased.

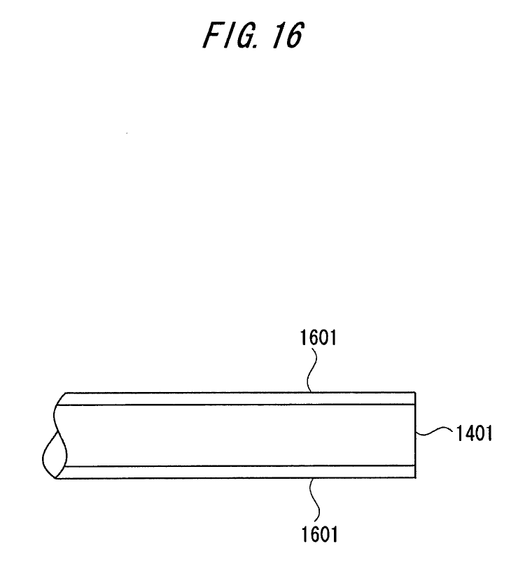

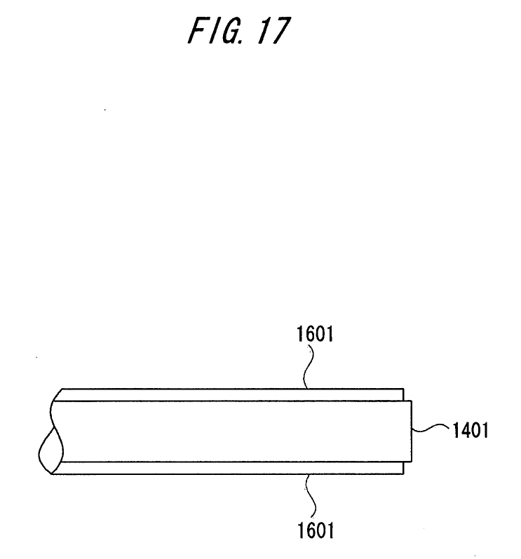

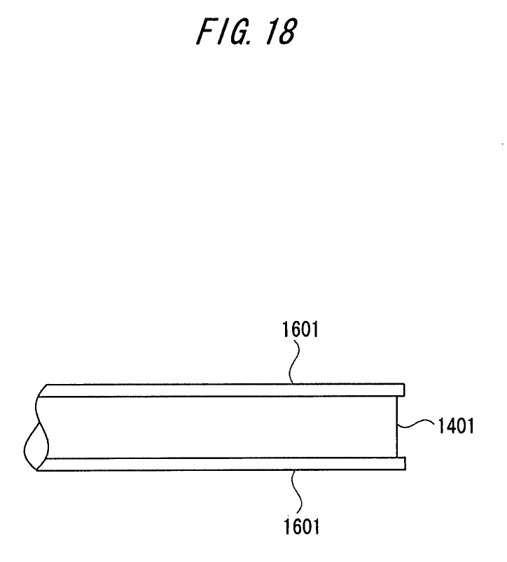

Moreover, as shown in FIG. 16, an outer peripheral surface of the tip of the optical fiber 1401 may be coated with a metal film 1601. Furthermore, as shown in FIG. 17, the outer peripheral surface of the tip of the optical fiber 1401 is coated with the metal film 1601, and the tip of the optical fiber 1401 may protrude from the metal film 1601. Still further, as shown in FIG. 18, the outer peripheral surface of the tip of the optical fiber 1401 is coated with the metal film 1601, and the metal film 1601 may protrude from the tip of the optical fiber 1401. Yet further, the structures of the tip of the optical fiber 1401 illustrated in FIGS. 14 through 18 may be combined.

In the first embodiment, the optical fibers 1401 shown in FIGS. 14 through 18 may be applied to the optical fiber 302 for the excitation light source and the optical fiber 303 for detecting the fluorescence.

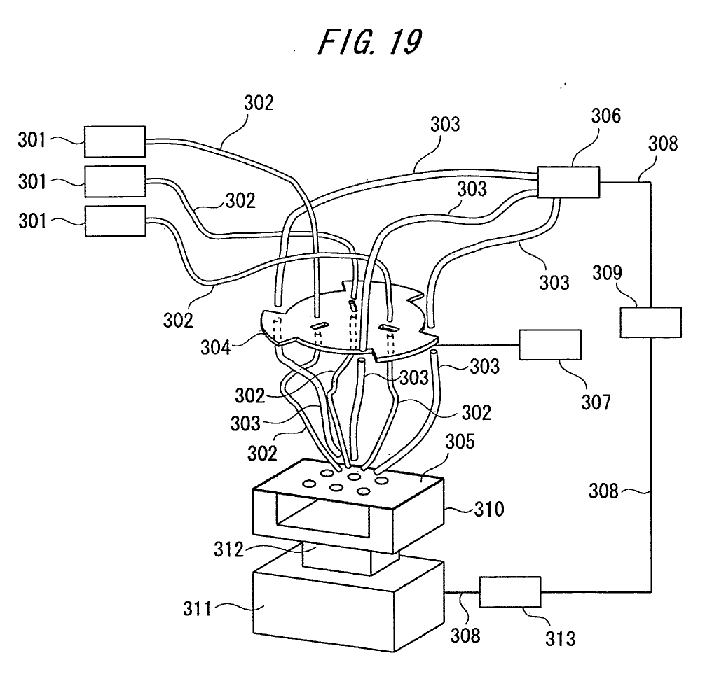

Next, FIGS. 19 through 21 illustrate specific examples of the configuration of the fluorescence detecting device in the first embodiment. The fluorescence detecting device shown in FIG. 19 includes the excitation light source 301, the optical fiber 302 for the excitation light source, the optical fiber 303 for detecting the fluorescence, the optical chopper 304, the to-be-measured object mounting base plate 305, the photo detector 306, the optical chopper controller 307, the personal computer 309, a base plate holder 310, an X-Y stage 311, a Z stage 312 and a stage controller 313. The X-Y stage 311 and the Z stage 312 are defined as sample stages for moving the to-be-measured object mounting base plate 305 on which an object to be measured is placed (mounted) in a predetermined direction.

The optical chopper 304 is connected to the optical chopper controller 307. The optical chopper controller 307 controls the rotations of the optical chopper 304. The photo detector 306 and the personal computer 309 are connected to each other via the bus 308. The personal computer 309 and the stage controller 313 are connected to each other via the bus 308. The X-Y stage 311 and the stage controller 313 are connected to each other via the bus 308. The stage controller 313 controls the X-Y stage 311 and the Z stage 312.

The optical chopper 304, the base plate holder 310, the X-Y stage 311, the Z stage 312 and the measured object are disposed within an unillustrated dark box. The to-be-measured object mounting base plate 305, on which the measured object is placed, is disposed on the base plate holder 310. The base plate holder 310 is disposed on the Z stage 312. The Z stage 312 is disposed on the X-Y stage 311.

The X-Y stage 311 moves the base plate holder 310 in the horizontal direction. Accordingly, the fluorescence detecting device in the first embodiment moves the measured object placed on the base plate holder 310 in any direction (a desired direction within the horizontal plane) within the horizontal plane.

The Z stage 312 moves the base plate holder 310 in the vertical direction. Hence, the fluorescence detecting device in the first embodiment moves the measured object placed on the base plate holder 310 in the vertical direction.

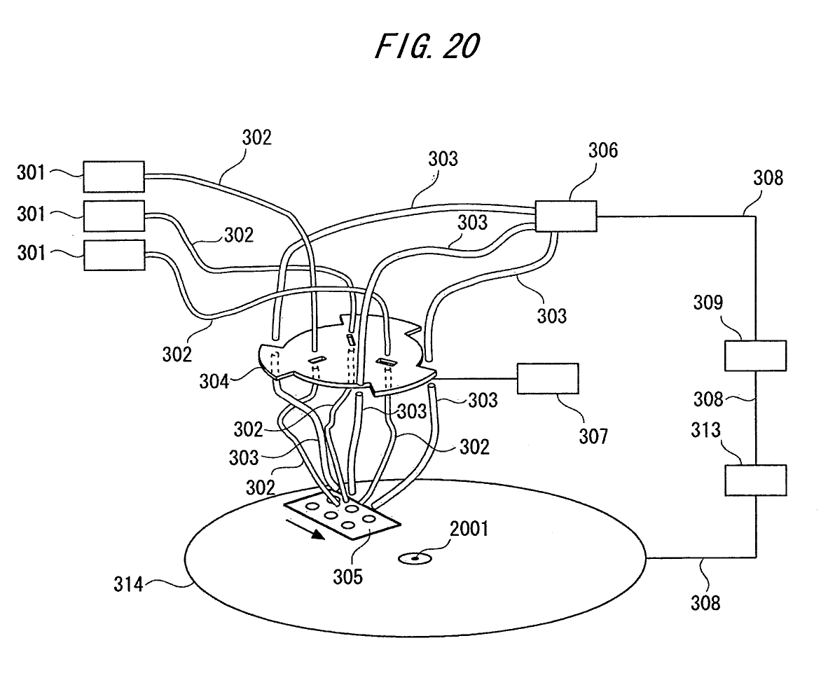

The fluorescence detecting device illustrated in FIG. 20 includes the excitation light source 301, the optical fiber 302 for the excitation light source, the optical fiber 303 for detecting the fluorescence, the optical chopper 304, the to-be-measured object mounting base plate 305, the photo detector 306, the optical chopper controller 307, the personal computer 309, and a rotary stage 314.

The optical chopper 304 is connected to the optical chopper controller 307. The optical chopper controller 307 controls the rotations of the optical chopper 304. The personal computer 309 and the stage controller 313 are connected to each other via the bus 308. The rotary stage 314 and the stage controller 313 are connected to each other via the bus 308. The stage controller 313 controls the rotary stage 314. The rotary stage 314 is a sample stage for moving the to-be-measured object mounting base plate 305 on which the measured object is placed in a predetermined direction.

The optical chopper 304, the rotary stage 314 and the measured object are disposed in an unillustrated dark box. The rotary stage 314 takes a disk-like shape, and the to-be-measured object mounting base plate 305, on which the measured object is placed, is disposed on the rotary stage 314. The rotary stage 314 rotates leftward and rightward about a central point 2001. As the rotary stage 314 rotates, the to-be-measured object mounting base plate 305, on which the measured object is placed, is moved in the rotating direction of the rotary stage 314. Namely, the measured object moves along on the same circumference about the central point 2001 of the rotary stage 314. Hence, the fluorescence detecting device in the first embodiment moves the measured object along on the same circumference about the central point 2001 of the rotary stage 314.

Moreover, the rotary stage 314 moves in an arrow direction shown in FIG. 20, thereby moving the to-be-measured object mounting base plate 305 on which the measured object is placed in the arrow direction illustrated in FIG. 20. Namely, the rotary stage 314 moves the measured object in the horizontal direction. Therefore, the fluorescence detecting device in the first embodiment moves the measured object in the horizontal direction.

The fluorescence detecting device shown in FIG. 20 includes the excitation light source 301, the optical fiber 302 for the excitation light source, the optical fiber 303 for detecting the fluorescence, the optical chopper 304, the to-be-measured object mounting base plate 305, the photo detector 306, the optical chopper controller 307, the personal computer 309, and a drum-shaped stage 315.

The optical chopper 304 is connected to the optical chopper controller 307. The optical chopper controller 307 controls the rotations of the optical chopper 304. The personal computer 309 and the stage controller 313 are connected to each other via the bus 308. The drum-shaped stage 315 and the stage controller 313 are connected to each other via the bus 308. The stage controller 313 controls the drum-shaped stage 315. The drum-shaped stage 315 is a sample stage for moving the to-be-measured object mounting base plate 305 on which the measured object is placed in a predetermined direction.

The optical chopper 304, the drum-shaped stage 315 and the to-be-measured object mounting base plate 305, on which the measured object is placed, are disposed in an unillustrated dark box. The drum-shaped stage 315 takes a cylindrical shape, and the to-be-measured object mounting base plate 305, on which the measured object is placed, is disposed on the drum-shaped stage 315.

The drum-shaped stage 315 rotates leftward and rightward about a central point 2101. As the drum-shaped stage 315 rotates, the measured object is moved in the rotating direction of the drum-shaped stage 315. Namely, the measured object moves along on the same circumference about the central point 2101 of the drum-shaped stage 315. Hence, the fluorescence detecting device in the first embodiment moves the measured object along on the same circumference about the central point 2101 of the drum-shaped stage 315.

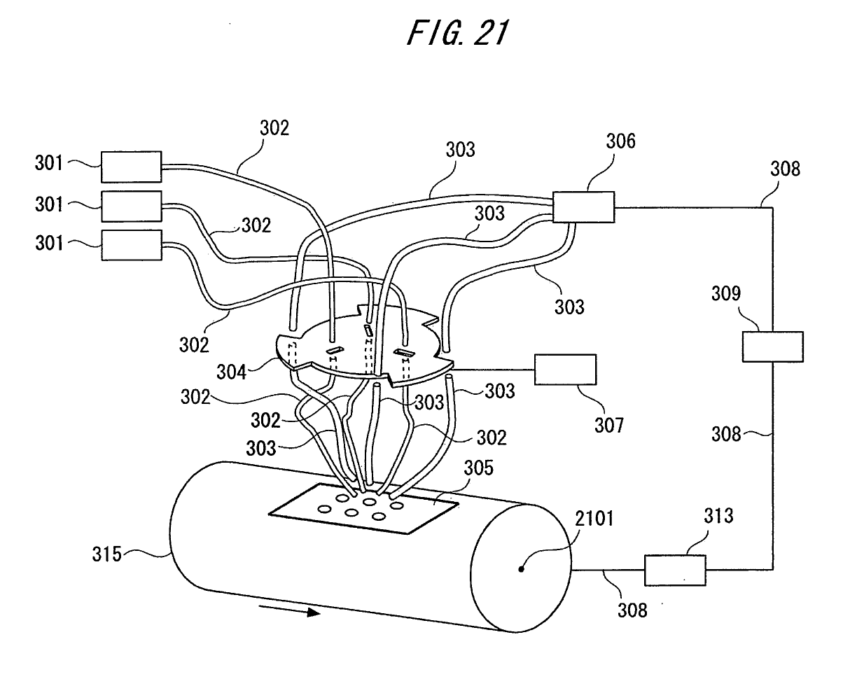

Moreover, the drum-shaped stage 315 moves in an arrow direction shown in FIG. 21, thereby moving the measured object in the arrow direction illustrated in FIG. 21. Therefore, the fluorescence detecting device in the first embodiment moves the measured object in the horizontal direction.

A relationship between the position of the optical fiber 302 for the excitation light source, on which the fluorescence get incident, and the fluorescence intensity detected in this position, may be measured by any one of the fluorescence detecting devices illustrated in FIGS. 19 through 21. In this case, the personal computer 309 executes a measurement program for measuring the relationship between the position of the optical fiber 302 for the excitation light source, on which the fluorescence get incident, and the fluorescence intensity detected in this position, thus enabling the measurement to be actualized.

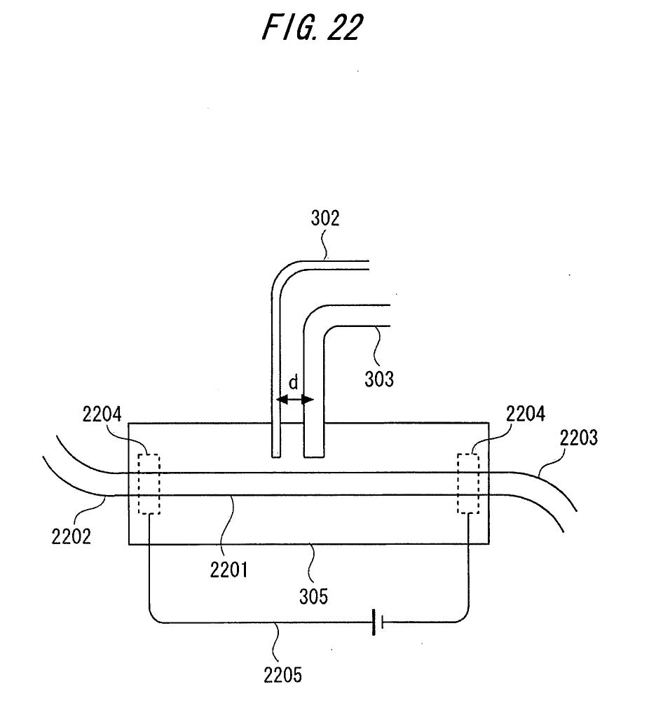

Given next is an explanation of a configuration of the fluorescence detecting device that detects the fluorescence emitted from the fluorescence-marked measured object after the excitation light has impinged on the fluorescence-marked measured object passing through within a flow path. FIG. 22 is a top view of the to-be-measured object mounting base plate 305 formed with a flow path 2201. The to-be-measured object mounting base plate 305 takes a box shape and has a cavity inside. In this case, the to-be-measured object mounting base plate 305 may be made of glass.

As illustrated in FIG. 22, the flow path 2201 is formed within the to-be-measured object mounting base plate 305. To be specific, the cavity may be constructed by boring a hole through the to-be-measured object mounting base plate 305. A box-shaped body may be assembled by glass plate members. Further, the flow path 2201 is formed inside the cavity. Moreover, the flow path 2201 is formed from a material that transmits the excitation light and the fluorescence.

The to-be-measured object mounting base plate 305 is provided with pipes 2202 and 2203. The pipe 2202 is connected to an entrance port of the flow path 2201. Further, the pipe 2203 is connected to an exit port of the flow path 2201. A liquid measured object is supplied into the flow path 2201 from the pipe 2202.

Transparent electrode films 2204 are provided at the entrance port and at the exit port of the flow path 2201. Then, the transparent electrode film 2204 provided at the entrance port of the flow path 2201 is electrically connected via a conducting wire 2205 to the transparent electrode film 2204 provided at the exit port of the flow path 2201. The conducting wire 2205 is provided with a power supply voltage. The power supply voltage applies a voltage to within the flow path 2201 via the conducting wire 2205. The transparent electrode film 2204 involves employing, e.g., gold and platinum.

When applying the voltage to within the flow path 2201, the liquid measured object in the flow path 2201 moves in electrophoresis to the exit port of the flow path 2201. Therefore, the liquid measured object supplied from the pipe 2202 moves to the exit port of the flow path 2201 from the entrance port of the flow path 2201. Then, the liquid measured object is discharged outside the flow path 2201 via the pipe 2202.

A fluorescence marking agent is adhered to a specified substance of the liquid measured object supplied to the flow path 2201. Then, the excitation light impinges upon the liquid measured object flowing inside through the flow path 2201. In this case, the incidence of the excitation light is attained via the optical fiber 302 for the excitation light source. The optical fiber 302 for the excitation light source is provided in a position enabling the excitation light to impinge upon the liquid measured object flowing inside through the flow path 2201. In this instance, the tip of the optical fiber 302 for the excitation light source may be set on the upper surface of the flow path 2201. Further, the tip of the optical fiber 303 for detecting the fluorescence may also be set on the upper surface of the flow path 2201.

The fluorescence emitted from the fluorescence-marked measured object is detected via the optical fiber 303 for detecting the fluorescence. Specifically, the fluorescence emitted from the fluorescence-marked measured object gets incident on the optical fiber 303 for detecting the fluorescence. Then, the fluorescence incident on the optical fiber 303 for detecting the fluorescence is detected by the photo detector 306.

Further, an interval d between the optical fiber 302 for the excitation light source and the optical fiber 303 for detecting the fluorescence is determined based on a flow speed (of the liquid measured object flowing inside through the flow path 2201) and on a delay characteristic of the fluorescence of the fluorescence marking agent. The to-be-measured object mounting base plate 305 formed with the flow path 2201, which is exemplified in the first embodiment, may also be disposed on the Z stage 312 of the fluorescence detecting device illustrated in FIG. 19. The first embodiment enables the detection of the fluorescence emitted by the fluorescence marking agent adhered to the specified substance.

With the use of the configuration described above, the fluorescence detecting device in the first embodiment simplifies the device itself. With the use of the configuration described above, the fluorescence detecting device in the first embodiment downsizes the device itself.

### Second Embodiment

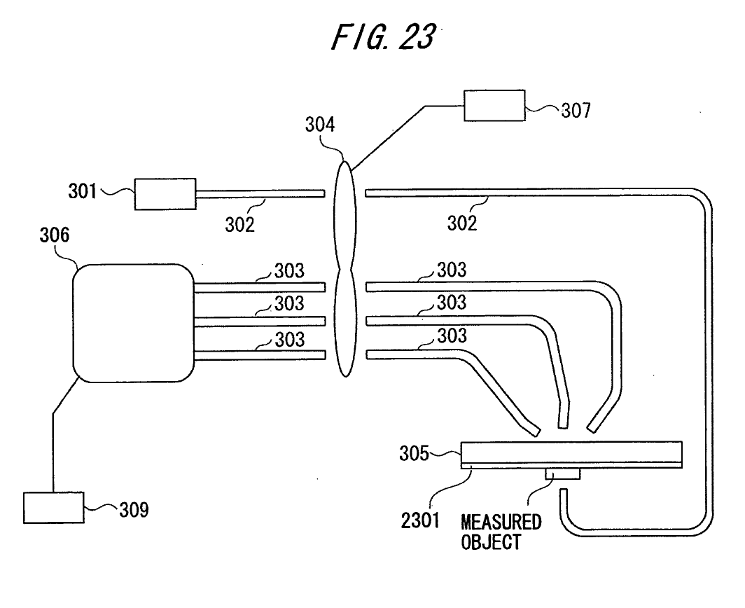

The fluorescence detecting device according to a second embodiment of the present invention will be described with reference to FIG. 23. The second embodiment of the present invention, as shown in FIG. 23, may take such a scheme that a rear surface of the to-be-measured object mounting base plate 305 is irradiated with the excitation light, and the excitation light thus impinges on the fluorescence-marked measured object. Other configurations and operations are the same as in the first embodiment. Such being the case, the same components are marked with the same numerals and symbols as those in the first embodiment, and their explanations are omitted. Further, the drawings in FIGS. 3 through 22 will be referred to when the necessity arises.

The second embodiment of the present invention may have a further increase in the number of the optical fibers 303 for detecting the fluorescence according to the necessity. Therefore, an incidence efficiency of the fluorescence upon the photo detector 306 is further improved. In the case of employing a plurality of optical fibers 303 for detecting the fluorescence, the optical fibers 303 for detecting the fluorescence are bundled.

Further, the use of the plurality of optical fibers 303 for detecting the fluorescence involves employing a multiplexer. The fluorescence, after passing through the optical chopper 304, is led to the photo detector 306 even when using the plurality of optical fibers 303 for detecting the fluorescence by bundling the optical fibers 303 for detecting the fluorescence and using the multiplexer. For instance, the bundled optical fibers 303 for detecting the fluorescence are disposed at a photoelectron multiplier and on a light receiving surface of a semiconductor light receiving element.

Moreover, as illustrated in FIG. 23, the fluorescence-marked measured object may be disposed on the rear surface of the to-be-measured object mounting base plate 305. In this case, the rear surface of the to-be-measured object mounting base plate 305 is attached with an excitation light cut filter 2301 that blocks the excitation light. The excitation light cut filter 2301 attached to the rear surface of the to-be-measured object mounting base plate 305 restrains the excitation light from getting incident on the optical fiber 303 for detecting the fluorescence. The fluorescence penetrates the to-be-measured object mounting base plate 305 and is therefore incident on the optical fiber 303 for detecting the fluorescence. Accordingly, only the fluorescence is detected.

FIG. 23 shows the configuration that the excitation light cut filter 2301 is attached to the to-be-measured object mounting base plate 305. A configuration that the excitation light cut filter 2301 is not attached to the to-be-measured object mounting base plate 305, may also be available.

### Third Embodiment

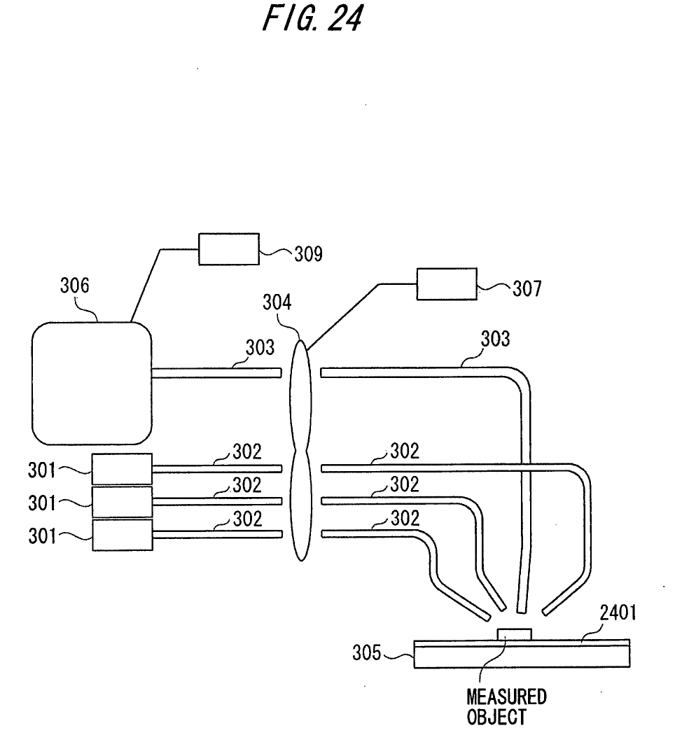

The fluorescence detecting device according to a third embodiment of the present invention will be described with reference to FIG. 24. In the third embodiment of the present invention, the fluorescence is detected via the single optical fiber 303 for detecting the fluorescence. Other configurations and operations are the same as in the first embodiment. Such being the case, the same components are marked with the same numerals and symbols as those in the first embodiment, and their explanations are omitted. Further, the drawings in FIGS. 3 through 22 will be referred to when the necessity arises. As illustrated in FIG. 24, the fluorescence is detected via the single optical fiber 303 for detecting the fluorescence. The detection of the fluorescence via the single optical fiber 303 for detecting the fluorescence can make variable the intensity of the fluorescence.

Moreover, a fluorescence reflective layer 2401 may also be provided on the to-be-measured object mounting base plate 305. For example, an aluminum evaporated film is used as the fluorescence reflective layer 2401. The fluorescence reflective layer 2401 is provided on the to-be-measured object mounting base plate 305, thereby restraining the to-be-measured object mounting base plate 305 from being radiated with the excitation light and the fluorescence. As a result, the intensity of the fluorescence detected by the photo detector 306 rises, and the detection with a high sensitivity is attained.

### Others

The disclosures of Japanese patent application No. JP2006-301610 filed on Nov. 7, 2006 including the specification, drawings and abstract are incorporated herein by reference.

What is claimed is:

1. A fluorescence detecting device comprising:
an excitation light source emitting excitation light that excites a fluorescence-marked measured object; a first optical path via which the excitation light impinges on the fluorescence-marked measured object;
a detector detecting fluorescence emitted when the excitation light impinges on the fluorescence-marked measured object;
a second optical path via which the fluorescence gets incident on said detector; and
a chopper chopping the excitation light passing through said first optical path and the fluorescence passing through said second optical path, and thus controlling a relative relationship between a passage period of the excitation light and a passage period of the fluorescence.

2. The fluorescence detecting device according to claim 1, wherein said first optical path includes two optical paths connected to each other at their connecting ends facing each other,
said second optical path includes two optical paths connected to each other at their connecting ends facing each other, and
said chopper, which is a rotary type of optical chopper, controls a light cutting state and a light transmitting state between the connecting ends, facing each other, of said first optical path and between the connecting ends, facing each other, of said second path, and changes the relative relationship between the passage period of the excitation light and the passage period of the fluorescence by changing the number of rotations of said optical chopper.

3. The fluorescence detecting device according to claim 1, wherein said first optical path and said second optical path are optical fibers, and
said optical fibers each take a convex shape at their tips facing the measured object.

4. The fluorescence detecting device according to claim 1, wherein said first optical path and said second optical path are optical fibers, and
a divergence angle adjusting member is provided at an incidence port of said optical fiber.

5. The fluorescence detecting device according to claim 1, wherein said first optical path and said second optical path are optical fibers, and
said optical fiber is covered with a metal along an outer periphery of its tip facing the measured object.

6. The fluorescence detecting device according to claim 1, further comprising a moving device moving the measured object in a predetermined direction,
wherein said first optical path is a path via which the excitation light impinges on the measured object moved in the predetermined direction, and
said second optical path is a path via which the fluorescence emitted from the measured object moved in the predetermined direction enters said detector.

7. The fluorescence detecting device according to claim 6, wherein said moving device further includes a disc-like sample stage on which the measured object is placed, and
said disc-like sample stage rotates or moves in a predetermined direction, thereby moving the measured object in the predetermined direction.

8. The fluorescence detecting device according to claim 6, wherein said moving device further includes a cylindrical sample stage on which the measured object is placed, and
said cylindrical sample stage rotates or moves in a predetermined direction, thereby moving the measured object in the predetermined direction.

9. A fluorescence detecting device according to claim 1, further comprising a flow path through which the measured object passes,
wherein said first optical path is a path via which the excitation light impinges on the measured object passing through said flow path, and
said second optical path is a path via which the fluorescence emitted from the measured object passing through said flow path enters said detector.
